(19) United States
(12) Patent Application Publication
(10) Pub. No.: US 2005/0021480 A1
(43) Pub. Date: Jan. 27, 2005

(54) Method and apparatus for creating and validating an encrypted digital receipt for third-party electronic commerce transactions

(75) Inventors: Maurice W. Haff, Easton, MD (US); Christopher Fahey, Denton, MD (US)

Correspondence Address: GREENBLUM & BERNSTEIN, P.L.C., 1950 ROLAND CLARKE PLACE, RESTON, VA, 20191, US

(73) Assignee: HYPERSPACE COMMUNICATIONS, INC., Easton, MD (US)

(21) Appl. No.: 10/844,387

(22) Filed: May 13, 2004

Related U.S. Application Data
(60) Provisional application No. 60/470,867, filed on May 16, 2003.

(51) Int. Cl. G06F 17/60

(52) U.S. Cl. 705/75

(57) ABSTRACT

A method and apparatus provide digital receipts for third-party electronic commerce transactions, using a Web Receipt Service. The digital receipts can be used to validate the details of electronic transactions carried out over public networks such as the Internet. A Web service provides a digital receipt comprising a transaction record identifying transaction details. The transaction record is sent to the Web Receipt Service, where a computer controlled by the Web Receipt Service digitally signs and encrypts the record. The transaction record is encrypted such that it may be later decrypted only by the Web Receipt Service and cannot be altered by others. A digital receipt is formed comprising the encrypted transaction record, which may be embedded in a graphic using steganography to enable display in a Web page. The digital receipt containing the encrypted transaction record is returned electronically to each of the parties to the transaction. The digital receipt may be formed in real-time, so that it can be made an integral part of the electronic commerce transaction. The Web Receipt Service need not store the digital receipts. Each party may later present the digital receipt to the Web Receipt Service for verification. The Web Receipt Service decrypts the transaction record and returns the transaction record so that the parties may then compare the decrypted transaction record to any previously stored version they may possess.

### CROSS REFERENCE TO RELATED APPLICATION

This application is based on and claims the benefit of the filing date of U.S. provisional application Ser. No. 60/470,867, filed May 16, 2003, and incorporated herein by reference in its entirety.

### REFERENCE TO COMPUTER PROGRAM LISTING APPENDIX

Seventeen computer program listing Appendices on compact disc-read only memory (CD-ROM), containing Appendices 1-17 that correspond to sections 1-17 referenced in the present specification, are filed herewith, in accordance with 37 C.F.R. § 1.52(e). The computer program listing Appendices are incorporated by reference in their entirety, in accordance with 37 C.F.R. § 1.77(b)(4). Each of the Appendices was created on May 12, 2004. The computer program listing Appendices are identified as follows

| Name | Size | Type |
|---|---|---|
| P23788APPENDIX1 | 4413 bytes | Text Document |
| P23788APPENDIX2 | 733 bytes | Text Document |
| P23788APPENDIX3 | 381 bytes | Text Document |
| P23788APPENDIX4 | 456 bytes | Text Document |
| P23788APPENDIX5 | 486 bytes | Text Document |
| P23788APPENDIX6 | 1535 bytes | Text Document |
| P23788APPENDIX7 | 959 bytes | Text Document |
| P23788APPENDIX8 | 1402 bytes | Text Document |
| P23788APPENDIX9 | 3704 bytes | Text Document |
| P23788APPENDIX10 | 1952 bytes | Text Document |
| P23788APPENDIX11 | 1115 bytes | Text Document |
| P23788APPENDIX12 | 843 bytes | Text Document |
| P23788APPENDIX13 | 1632 bytes | Text Document |
| P23788APPENDIX14 | 2186 bytes | Text Document |
| P23788APPENDIX15 | 725 bytes | Text Document |
| P23788APPENDIX16 | 1515 bytes | Text Document |
| P23788APPENDIX17 | 1497 bytes | Text Document |

A portion of the disclosure of this patent document contains material that is subject to copyright protection. The copyright owner has no objection to the facsimile reproduction by anyone of the patent document or the patent disclosure, as it appears in the Patent and Trademark Office patent file records, but otherwise reserves all copyright rights whatsoever.

### BACKGROUND OF THE INVENTION

1. Field of the Invention

The present invention relates to the field of electronic commerce conducted over public computer networks, and more particularly to creating and validating digital receipts for third-party electronic transactions.

2. Description of Related Art

Public networks are used widely for conducting electronic transactions, including auctions, banking, trading, claim submissions, benefit requests, and the purchase of goods and services. Electronic transactions are often performed using computers configured to enable communications over the World Wide Web.

Web services are a new and rapidly expanding set of offerings on the World Wide Web. Web services leverage the existing scalable web server infrastructure to provide a platform for offering services to other Internet applications.

In a typical electronic commerce transaction, a customer connects to a merchant's web site, where the customer views product information or product descriptions. The customer may then proceed to order goods or services, typically using an ordering template comprising HTML pages displayed by a Web browser running on the customer's computer. The customer may elect to make payment in the transaction using, e.g., credit card accounts, debit card accounts, a PayPal account, or another method of transferring funds electronically. Merchants or institutions may acknowledge to the customer specific details of the transaction by returning an e-mail confirmation, returning a confirmation page that can be printed, or simply providing a confirmation number.

All of the foregoing forms of acknowledgment are intended to document the transaction and indicate to the customer that the transaction has been completed successfully. However, in the event of a dispute over the details of the transaction, such acknowledgments provide only limited utility. Acknowledgments in the form of e-mail are not an interactive element in the transaction, are easily modified, and may be delayed or prevented from arriving entirely. Additionally, while confirmation pages are interactive and provided in real-time, they may also be easily compromised. Furthermore, confirmation numbers do not document transaction details at all, and provide only a reference for use in later correspondence.

Additionally, Robinson et al. (U.S. Pat. No. 5,915,022) teach a method for creating a transaction record, which identifies the electronic transaction to one party, typically a merchant. A computer controlled by a merchant encrypts each transaction record. The encrypted transaction record is appended to a message that describes the transaction in plain text to form a digital receipt. The digital receipt is then communicated to a computer controlled by the customer. In the case of a dispute or other failure, the customer may present the digital receipt to the merchant. The merchant may thereafter authenticate the transaction by, e.g., decrypting the transaction record and comparing the decrypted transaction record to a version of the transaction record previously stored on a database controlled by the merchant.

The method taught by Robinson et al. suffers from a number of limitations. For example, the customer may not trust that the merchant accurately represented the transaction in the encrypted record, because the customer cannot view the content of the receipt. Additionally, if the merchant does not employ robust, fault-tolerant computer systems, the cryptographic elements necessary to decrypt a transaction record may be lost. Additionally, the transaction records stored by the merchant may be lost. As a result, a merchant using the method of Robinson et al. may require a dual system of encrypted and non-encrypted transaction records, increasing cost and complexity.

Increasing customer trust in Internet transactions may result in greater growth in the volume of business conducted in the form of electronic commerce. Because electronic commerce is typically more efficient than more traditional forms of conducting business, goods and services can be delivered at lower cost. This benefits merchants, customers, and the overall economy.

Therefore, the growth in the number of Internet transactions and difficulty in resolving disputes in electronic transactions conducted over the Internet has increased the need to provide trusted, convenient, low cost and reliable authentication of such transactions. Accordingly, a method for creating and validating an encrypted digital receipt for third-party electronic commerce transactions is needed.

### SUMMARY OF THE INVENTION

In view of the foregoing, the present invention is directed to providing a method and apparatus for authenticating electronic transactions carried out over public networks such as the Internet.

The present invention is further directed toward providing a digital receipt that can be used to authenticate electronic transactions over public networks, independent of transaction content format, e.g., voice, data or text.

The present invention is also directed toward providing all parties to an electronic transaction with a relatively high level of confidence that a digital receipt issued by one party accurately represents information regarding the transaction.

According to an aspect of the present invention, a method and apparatus are provided for authenticating, using a third-party Web Receipt Service, an electronic transaction carried out over a public network.

According to another aspect of the present invention, a Web Receipt Service creates “postmarked” receipts suitable for use within a web browser, where the postmark includes a date time stamp and identity of a trusted third party.

According to still another aspect of the present invention, a Web Receipt Service is accessible using standard web based protocols. In an embodiment, the postmarked receipts from the Web Receipt Service consist of small graphics suitable for rendering in web pages. The postmarked receipts offer end-users a trustworthy assurance and proof that the merchant has performed or will perform a stated task and/or has provided or will provide a stated service.

According to yet another aspect of the present invention, the Web Receipt Service can be used in situations where a customer uses an Internet service to have work performed. In an embodiment of the present invention, after concluding the requested work for that customer, the service creates a description of the work performed. The service then contacts the Web Receipt Service and sends the Web Receipt Service the work description and a transformation document. The Internet service receives a Web Receipt from the Web Receipt Service in return for the work description and the transformation document.

According to an aspect of the present invention, a link is provided to return web pages that detail the results of the Internet transactions as a “pseudo-receipt.”

In an embodiment, the present invention is also directed toward providing a Web Service so that integrating postmarked receipts includes passing a description of a financial transaction to the Web Receipt Service over an encrypted connection and subsequently placing the postmark receipt graphic within the web page sent back to the user.

According to another aspect of the present invention, a process begins with a client making a request of a server that offers a service. After the successful conclusion of the service, the server sends a copy of the work performed and the rules for decrypting the work description. When the Web Receipt Service receives the request, the Web Receipt Service passes a time-stamped hash of the work description to the postmarking service or the Web Receipt Service generates a postmark. Once a postmark is generated by the Web Receipt Service or received from the postmarking service, a Web Receipt is created and returned to the requesting service. The requesting service then has the option of keeping the Web Receipt or returning it to the client.

According to still another aspect of the present invention, a Web Receipt Service allows third party web services to create receipts that carry both sensitive and non-sensitive information. Sensitive information includes credit card or social security numbers, or other information that may be subject to privacy laws and regulations such as healthcare records and patient data. Non-sensitive information may include exactly what was purchased, the identity of the seller and the time and/or date of the sale. The third party web service may be allowed to specify the ability of the user to access sensitive information, and may establish the corresponding controls.

According to yet another aspect of the present invention, a Web Receipt Service includes a server-based receipting application. In an embodiment, the Web Receipt Service provides a postmarked receipt, a third party receipt and a style sheet. Together, the components of the Web Receipt Service can provide third party applications or systems with the ability to issue Web Receipts for transactions, tasks or work performed.

Furthermore, according to another aspect of the present invention, a Web Receipt Service has the responsibility for creating the Web Receipt. In an embodiment, the Web Receipt Service resides on the Internet and can be accessed using standard web service protocols such as SOAP or XML-RPC. Connections to the Web Receipt Service application are made over a secure connection such as SSL in order to protect sensitive information.

In an embodiment, the present invention is a Web Receipt Service that creates an XML receipt and accompanying style sheet in XSLT and sends the XML receipt and/or the accompanying style sheet to a postmarking application. The postmarking application then uses a postmarking service to create the time-stamped hash of the receipt. Postmarking may also include digitally signing the receipt.

According to still another aspect of the present invention, transaction records and time-stamped hash are encoded and combined into an XML document which is protected through the use of standard PKI based encryption and the public key of the verification application.

According to yet another aspect of the present invention, encrypted data is encoded again, injected into a GIF image using steganography and returned to the third party service.

In an embodiment, the present invention is directed toward providing a Web Receipt Service that provides a server-based verification application, a postmarked receipt, and a third party receipt and style sheet.

According to another aspect of the present invention a Web Receipt Service is provided with a verification application that resides in a web server and is accessible to end users from the Internet or other public network through a web browser.

In an embodiment, the present invention is directed toward providing a Web Receipt Service with a verification application that allows a user to view non-sensitive information contained within the Web Receipt while, at the same time, verifying that the Web Receipt is valid.

According to another aspect of the present invention, a Web Receipt Service with a verification application decomposes a Web Receipt by reversing the process used to construct the Web Receipt in order to obtain the original time-stamped hash, XML receipt and style sheet.

In an embodiment, the present invention is additionally directed toward providing a Web Receipt Service so that a time-stamped hash is validated using the postmarking service. When the time-stamped hash is valid, the Web Receipt Service performs the XSL transformation on the XML formatted receipt in order to create a displayable receipt with the sensitive information filtered out.

According to yet another aspect of the present invention, a displayable receipt is returned to the user's web browser, where it may be saved on the user's computer and accessed again at a later time. The receipt is portable and may be moved to another device, where the receipt content may be viewed after verification.

According to still another aspect of the present invention, a Web Receipt Service provides Web Receipts that are designed to be self-containing, protective, usable, and treated as opaque values. The Web Receipts carry the time-stamped hash of the receipt, the original receipt created by the third party service, and the style sheet. The present invention mitigates the need to store any information required in order to display the receipt when requested. The receipt may be validated and the content viewed on any computer providing access to the verification service.

In an embodiment, encryption is performed using DES3, RSA or another PKI algorithm, and the only certificates and cryptographic keys used are those issued to the Web Receipt Verification Service. The present invention protects the Web Receipts from tampering and unauthorized access.

In another embodiment, the present invention is additionally directed toward providing a Web Receipt Service that uses PKI, but that does not rely upon the issuance of certificates or private keys to the individuals for whom the Web Receipts are created.

According to an aspect of the present invention, the receipt is protected through encryption to a single public key belonging only to the Web Receipt Service. Only the Web Receipt Service can decrypt the receipt.

According to an aspect of the present invention, a Web Receipt Service is provided so that sensitive information is never revealed to anyone in a standard verification transaction, including the user requesting to view the receipt. The sensitive information is protected by using XSL transformations (XSLT) with the XML formatted receipt. Using XSLT strips out any sensitive information and transforms the rest of the XML receipt into a displayable format. Accordingly, non-sensitive details about the transaction or work performed are displayed while sensitive details required only to resolve a dispute are not unnecessarily revealed. The verification service of the Web Receipt Service controls access to sensitive details, and may provide these when required in accordance with specified rules of a particular business process.

According to still another aspect of the present invention, steganography is employed to allow the postmarked receipts to be usable within a web browser environment as a graphic in web pages. While steganography can be used to provide some data-hiding protection for the content, the present invention employs steganography technology to facilitate using graphics displayable in a web page and to hold the postmarked receipt.

In an embodiment, the present invention is directed toward using steganography by taking a GIF image and manipulating the image in a way that allows the data of the postmarked receipt to be spread across the bits that make up a color map.

According to another aspect of the present invention, a Web Receipt Service is provided that does not require detailed specifics of third party service receipts, such that all receipts are treated as opaque pieces of data aside from the use of XML and XSL transformations (XSLT). In an embodiment, the present invention allows any well-formed and valid XML receipt to be processed by using standard off-the shelf XML parsing engines and passing the result through.

In another embodiment, the present invention is additionally directed toward providing a Web Receipt Service wherein all elements are first encoded using the MIME base-64 encoding standard. The encoded elements are inserted as data of the elements to which they belong, in order to embed the elements, e.g., an XML document or binary data, within an XML document.

According to an aspect of the present invention, a device provides a digital receipt for a third-party electronic commerce transaction carried out over a public network. The receipt validates details of the electronic transaction and includes a transaction record identifying transaction details. The device includes a receipt system that receives the transaction record detailing a completed transaction, digitally signs and encrypts the transaction record, forms a digital receipt comprising the encrypted transaction record, embeds the digital receipt in a graphic to enable display in a Web page, and returns the digital receipt to at least one party to the completed transaction. Details in the transaction record are protected from modification by the parties to the transaction.

According to another aspect of the present invention, the device also includes a verification system to which each party may later present the digital receipt for verification. The verification includes extracting the digital receipt from the graphic, decrypting the transaction record and returning details of the transaction to the presenting party. The presenting party may compare the transaction details to a previously stored version of the transaction record.

According to still another aspect of the present invention, the device provides a Web Receipt Service that creates “postmarked” digital receipts suitable for use within a web browser. The postmark includes a date time stamp and identity of a trusted third party.

According to yet another aspect of the present invention, the trusted third party is a national postal authority.

According to another aspect of the present invention, the Web Receipt Service is accessible using standard web based protocols.

According to still another aspect of the present invention, the Web Receipt Service generates a postmark or passes a time-stamped hash of the transaction details to a postmarking service.

According to an aspect of the present invention, a Web Receipt system provides a Web Service. The Web Receipt system includes a receipt originating device and a server-based receipting application. The Web Receipt system generates a postmarked receipt and a third party receipt and style sheet. Third parties are enabled to issue Web Receipts for tasks accomplished or work performed in electronic transactions.

According to another aspect of the present invention, access uses standard Web Service protocols and connections are made over a secure SSL connection to protect sensitive information.

According to still another aspect of the present invention, an XML receipt and accompanying style sheet in XSLT are created and sent to a postmarking application. The postmarking application uses a postmarking service to create a time-stamped hash of the receipt.

According to yet another aspect of the present invention, transaction records and time-stamped hash are encoded and combined into an XML document which is protected through the use of standard PKI based encryption and the public key of a verification application.

According to another aspect of the present invention, encrypted transaction records are encoded and then injected into a GIF image using steganography and returned to a third party service.

According to still another aspect of the present invention, encryption is performed using DES3, RSA or another PKI algorithm, and the only certificates and cryptographic keys used are those issued to a Web Receipt Verification Service.

According to yet another aspect of the present invention, a Web Receipt Service uses PKI but does not rely upon the issuance of certificates or private keys to the individuals for whom Web Receipts are created.

According to another aspect of the present invention, protection of the transaction details is accomplished through encryption to a single public key belonging only to the Web Receipt Service and only the Web Receipt Service can decrypt it.

According to still another aspect of the present invention, sensitive information is not revealed to anyone including the user requesting a view of the receipt.

According to yet another aspect of the present invention, XSLT is used to strip out any sensitive information and transform the rest of an XML receipt into a displayable format.

According to another aspect of the present invention, steganography is employed to hold the postmarked receipt and allow postmarked receipts to be usable within a web browser environment as a graphic in web pages.

According to still another aspect of the present invention, the steganography used takes a GIF image and manipulates the image in a way that allows the data of the postmarked receipt to be spread across the bits that make up a color map.

According to yet another aspect of the present invention, all receipts are treated as opaque pieces of data aside from the use of XML and XSL transformations (XSLT). Accordingly, any well-formed and valid XML receipt can be processed by using standard off-the shelf XML parsing engines and passing the result through.

According to another aspect of the present invention, all elements are first encoded using the MIME base-64 encoding standard, and then inserted as data of the elements they belong to, in order to embed an XML document or binary data within an XML document.

According to an aspect of the present invention, a Web Receipt verification system includes a receipt verification device and a server-based verification application. The Web Receipt verification system generates a postmarked receipt, and a third party receipt and style sheet. Web Receipts are verified using the server-based verification application that is accessible from a public network through a Web browser.

According to another aspect of the present invention, a verification application allows a user to view non-sensitive information contained within a Web Receipt, at the same time verifying that the Web Receipt is valid.

According to still another aspect of the present invention, a verification application decomposes a Web Receipt by reversing the process used to construct the Web Receipt in order to obtain the original time-stamped hash, XML receipt and style sheet.

According to yet another aspect of the present invention, a time-stamped hash is validated using the postmarking service, and if the time-stamped hash is valid, an XSL transformation is performed on the XML formatted receipt creating a displayable receipt with the sensitive information filtered out.

According to another aspect of the present invention, the displayable receipt is returned to a users Web browser.

According to still another aspect of the present invention, the Web Receipts are self-containing, protective, and treated as opaque values.

According to yet another aspect of the present invention, the Web Receipts carry with them the time-stamped hash of the receipt, the original receipt created by the third party service, and the style sheet, mitigating the need to store any information required to display the receipt when requested.

According to another aspect of the present invention, a computer readable medium stores a Web service program for providing a digital receipt as a Web Service for a third-party electronic commerce transaction carried out over a public network. The receipt validates details of the electronic transaction and includes a transaction record identifying transaction details. The medium includes at least one Web Service source code segment that receives the transaction record comprising details of a completed transaction; digitally signs and encrypts the record; forms a digital receipt comprising the encrypted transaction record; embeds the digital receipt in a graphic to enable display in a Web page; and returns the digital receipt to at least one party to the completed transaction. Details in the transaction record are protected from modification by the parties to the transaction.

According to another aspect of the present invention, each party may later present the digital receipt for verification. The verification includes extracting the digital receipt from the graphic, decrypting the transaction record and returning details of the transaction to the presenting party. The presenting party may then compare the transaction details to any previously stored version of the transaction details that the presenting party possesses.

According to still another aspect of the present invention, a Web Receipt Service creates “postmarked” digital receipts suitable for use within a Web browser, where the postmark includes a date time stamp and identity of a trusted third party.

According to yet another aspect of the present invention, the trusted third party is a national postal authority.

According to another aspect of the present invention, the Web Receipt Service is accessible using standard web based protocols.

According to still another aspect of the present invention, the Web Receipt Service passes a time-stamped hash of the transaction details to the postmarking service or self-generates a postmark.

According to yet another aspect of the present invention, a digital receipt as a Web Service for a third-party electronic commerce transaction carried out over a public network, the receipt validating details of the electronic transaction and including a transaction record identifying transaction details. The method includes creating the transaction record based upon details of a completed transaction; sending the transaction record to a computer that digitally signs and encrypts the record; forming a digital receipt comprising the encrypted transaction record; embedding the digital receipt in a graphic to enable display in a Web page; and returning the digital receipt to at least one party to the completed transaction. Details in the transaction record are protected from modification by the parties to the transaction.

According to another aspect of the present invention, each party may later present the digital receipt for verification. The verification includes extracting the digital receipt from the graphic, decrypting the transaction record and returning details of the transaction to the presenting party. The presenting party may then compare the transaction details to any previously stored version of the transaction details that the presenting party possesses.

According to still another aspect of the present invention, a Web Receipt Service creates “postmarked” digital receipts suitable for use within a web browser, where the postmark comprises a date time stamp and identity of a trusted third party.

According to yet another aspect of the present invention, the trusted third party is a national postal authority.

According to still another aspect of the present invention, the Web Receipt Service is accessible using standard Web based protocols.

According to another aspect of the present invention, the Web Receipt Service passes a time-stamped hash of the transaction details to the postmarking service or self-generates a postmark.

According to yet another aspect of the present invention, an XML receipt and accompanying style sheet in XSLT are created and sent to a postmarking application. The postmarking application uses a postmarking service to create a time-stamped hash of the receipt.

According to still another aspect of the present invention, transaction records and time-stamped hash are encoded and combined into an XML document which is protected through the use of standard PKI based encryption and the public key of a verification application.

According to another aspect of the present invention, encrypted transaction records are encoded and then injected into a GIF image using steganography and returned to a third party service.

According to yet another aspect of the present invention, encryption is performed using DES3, RSA or another PKI algorithm, and the only certificates and cryptographic keys used are those issued to a Web Receipt Verification Service.

According to another aspect of the present invention, a Web Receipt Service uses PKI but does not rely upon the issuance of certificates or private keys to the individuals for whom Web Receipts are created.

According to still another aspect of the present invention, protection of the transaction details is through encryption to a single public key belonging only to the Web Receipt Service and only the Web Receipt Service can decrypt it.

According to yet another aspect of the present invention, sensitive information is not revealed to anyone including the user requesting a view of the receipt.

According to another aspect of the present invention, XSLT is used to strip out any sensitive information and transform the rest of an XML receipt into a displayable format.

According to still another aspect of the present invention, steganography is employed to hold the postmarked receipt and allow postmarked receipts to be usable within a Web browser environment as a graphic in web pages.

According to yet another aspect of the present invention, the steganography used takes a GIF image and manipulates the image in a way that allows the data of the postmarked receipt to be spread across the bits that make up a color map.

According to another aspect of the present invention, all receipts are treated as opaque pieces of data aside from the use of XML and XSL transformations (XSLT), such that any well-formed and valid XML receipt can be processed by using standard off-the shelf XML parsing engines and passing the result through.

### BRIEF DESCRIPTION OF THE DRAWINGS

The present invention is further described in the detailed description which follows, by reference to the noted drawings, by way of non-limiting examples of preferred embodiments of the present invention, in which like reference numerals represent similar parts throughout several views of the drawings, and in which:

FIG. 1 is a flow chart showing a typical Web Receipt Service exchange, according to an aspect of the present invention;

FIG. 2 is a flow chart showing typical Web Verification Service exchange, according to an aspect of the present invention;

FIG. 3 illustrates Web Receipt Service components, according to an aspect of the present invention;

FIG. 4 illustrates an example of Web Receipt creation flow, according to an aspect of the present invention;

FIG. 5 illustrates an example of Web Receipt verification flow chart, according to an aspect of the present invention;

FIG. 6 illustrates Web Receipt Verification Service components, according to an aspect of the present invention;

FIG. 7 illustrates elements of a postmarked Web Receipt, according to an aspect of the present invention; and

FIG. 8 illustrates a typical Web Receipt XML structure, according to an aspect of the present invention.

FIG. 9 graphically illustrates a typical Web Receipt, according to an aspect of the present invention.

### DETAILED DESCRIPTION OF THE INVENTION

In view of the foregoing, the present invention, through one or more of its various aspects, embodiments and/or specific features or sub-components, is thus intended to bring out one or more of the advantages as specifically noted below.

The following embodiments of the invention will be described in the context of what a Web Receipt Service is, how such a service works, how the service can be constructed, the design of such a service, and a description of a typical service installation for use over the Internet or other public network.

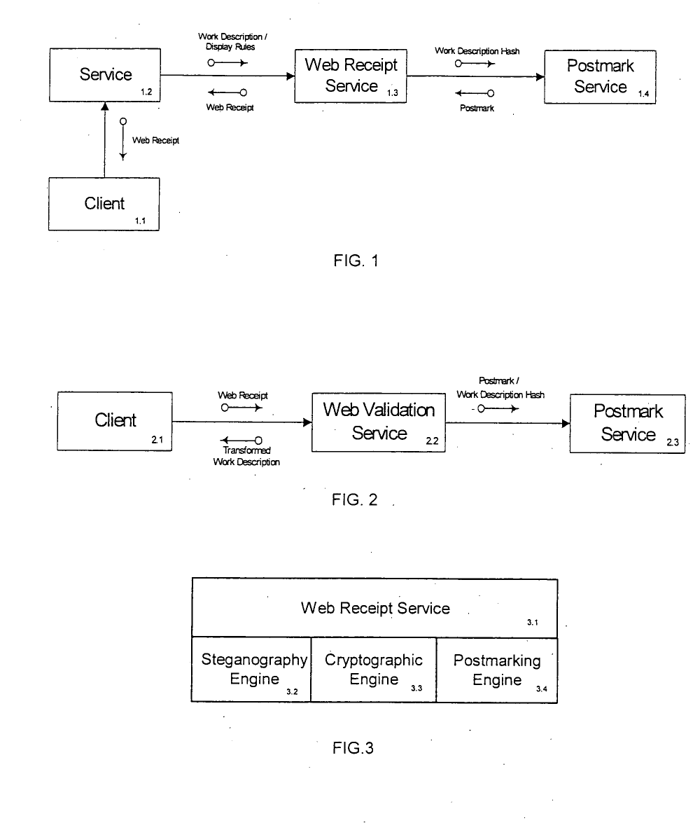

A flow chart illustrating an exemplary Web Receipt Service exchange is shown in FIG. 1. Simply stated, a Web Receipt Service provides a service that creates postmarked receipts suitable for use, e.g., display, within a web browser. The Web Receipt Service is accessible using standard web based protocols. The resulting postmarked receipts may consist of small graphics suitable for rendering in web pages. The postmarked receipts offer end-users an assurance that the stated work or task had been performed and offer proof that an event took place.

Referring now to FIG. 1, a Web Receipt Service could be used in situations where a client 1.1 uses a service 1.2 to have some work performed. After concluding the requested work for the client 1.1, the service creates a description of the work performed, e.g., transaction details. The service 1.2 then contacts the Web Receipt Service 1.3 and sends the Web Receipt Service 1.3 the description and a transformation document. In return, the service 1.2 receives a Web Receipt from the Web Receipt Service. The Web Receipt Service may provide its own postmarking function or the Web Receipt Service may interact with a trusted third-party date-time stamping service 1.4, such as those provided by the U.S. Postal Service (USPS), AuthentiDate, DigiStamp, and others. Typically interaction with a third-party date-time stamping service 1.4 involves submission of an industry standard, cryptographic hash code of the service originated work description by the Web Receipt Service 1.3 to the date-time stamping service 1.4 and return of the hash code processed with a date-time stamp and digital signature of the third-party date-time stamping service 1.4 to the Web Receipt Service 1.3.

In one preferred embodiment, the electronic postmark (EPM) of the USPS is employed for date-time stamping. For example, AuthentiDate provides the USPS EPM date-time stamping service under an outsourcing agreement with USPS, which is accessed using a software development kit (SDK), as is typical for third-party software utilities. Use of the USPS EPM brings certain legal protections to electronic transactions not available when alternative non-governmental date-time stamping services are employed. Legal protections afforded by the USPS EPM are delineated on the USPS Web site. Similar protections may be afforded when an electronic postmark of a national postal authority is applied in electronic transactions conducted within the jurisdiction of such a national postal authority.

Section 1 of the attached appendix shows an exemplary listing of computer readable software codes that may be used to obtain an electronic postmark from a third party date-time stamping service such as AuthentiDate.

An exemplary embodiment of the present invention implements the Web Receipt Service 1.3 for an Internet-based web store 1.2, (e.g., LL Bean, Amazon.com) selling products over the Internet. The web store 1.2 ordinarily uses return web pages detailing the results of a financial transaction as a “pseudo-receipt.” Integrating postmarked receipts into such a service requires an additional step of passing a description of the transaction to the Web Receipt Service 1.3 over an encrypted connection and subsequently placing the postmarked receipt graphic within the web page sent back to the user.

Referring again to FIG. 1, in a preferred embodiment of the present invention, the Web Receipt Service is accessed by a client 1.1 making a request of an Internet service 1.2 that uses a server (not shown) to offer an Internet service to the client 1.1. After the successful conclusion of the Internet service transaction, the server sends a copy of the transaction details or work performed and the rules for transforming the work description to the Web Receipt Service 1.3. When the Web Receipt Service 1.3 receives the request, the Web Receipt Service 1.3 passes a time-stamped hash of the work description to the postmarking service 1.4. After the Web Receipt Service 1.3 receives a postmark from the postmarking service 1.4, a Web Receipt is created and returned to the requesting Internet service 1.2. The service 1.2 then has the option of keeping the Web Receipt or returning it to the client 1.1. The client 1.1 may save the receipt as a record of the transaction for later use and verification in the event of a dispute or other need to access the content. Only the verification component of the Web Receipt Service 1.3 can “open” the receipt and deliver the content to the client 1.1 or the Internet service 1.2. The Web Receipt Service 1.3 cannot modify the content of the receipt without detection, because it has been “postmarked” with a date-time stamp and digitally signed.

In another preferred embodiment, an interface is used as the basis for a class that should be called to perform all of the service functionality of taking an XML work document, an XML style sheet, and an image, postmarking the XML work document and combining the elements into an XML formatted receipt document that is encrypted for a verification service. Steganography is used to embed the encrypted document into an image, which is returned to the caller.

Input Format:

The caller of the Web Receipt Service 1.3 has performed work that is to be certified by the Web Receipt Service 1.3. The caller creates a receipt as a document that describes the work that was performed. In a preferred embodiment, the document is an XML document. The caller also creates a document, such as a style sheet, that allows the receipt to be displayed inside a web browser. The receipt and the style sheet are passed to the Web Receipt Service 1.3. The receipt is then postmarked, and the postmark, the receipt, and the style sheet are returned by the Web Receipt Service 1.3 as a postmarked receipt.

Output Format:

In an embodiment, the postmarked receipt data is held within a steganographic image that has the receipt, the style sheet, and the postmark embedded within. The steganographic process takes a .gif file and, using a sorted color map, sets the “one” bit in a pixel to a higher or lower color map value depending on the bit found in the data to be inserted into the image. When the receipt image is returned, any alteration of the image data will alter the receipt itself. Therefore, use of image altering software on the image will render the receipt invalid, and is therefore detectable. Section 2 of the attached appendix shows an exemplary listing of computer readable software codes that may be used in creating a protected Web Receipt.

Section 3 of the attached appendix shows an exemplary listing of computer readable software codes that obtain the data that is passed in as strings and converts the strings to input streams so that the class that actually does the work can read the string data. The output of the process performed by the codes in Section 3 is a byte array making up an image that contains the postmarked receipt.

Now referring to FIG. 2, the Web Receipt Service provides a Web Receipt Verification Service 2.2. The design of the Web Receipt Service allows third party services, e.g., an Internet service 1.2, to create receipts that carry both sensitive and non-sensitive information that can later be validated. In electronic transactions involving product sales or services sales, sensitive information may include information such as a credit card number or Social Security Number. Non-sensitive information may include exactly what was purchased, the seller's identity, and the date and time of the purchase. In an embodiment, the present invention also allows the third party service to specify the accessibility of the user to sensitive information. A client 2.1 seeking receipt verification, which by way of example may be either a customer or a merchant, can submit the Web Receipt to the Web Receipt Verification Service 2.2 for verification. The Web Receipt Verification Service 2.2 decrypts the Web Receipt and can verify the postmark by validating its own date-time stamp or by communicating with the appropriate Postmarking Service 2.3 to verify the postmark. The Web Receipt Verification Service 2.2 returns the transformed work description detailing transaction information to the client 2.1.

In a preferred embodiment, Web Receipt verification is enabled as a class that is the verification service for Web Receipts generated by the Web Receipt class. The Web Receipt Verification Service 2.2 takes apart the steganographic image, decodes, decrypts, validates the XML, and validates the postmark on the XML receipt. A negative or a positive result is returned. In the case of a positive result, the receipt XML document and accompanying style sheet are provided to the caller. Section 4 of the attached appendix shows an exemplary listing of computer readable software codes that may be used in Web Receipt verification.

The steganographic image that is output by the receipt service has the receipt description embedded within. The steganographic process takes a .gif file and, using a sorted color map, sets the “one” bit in a pixel to a higher or lower color map value depending on the bit found in the data to be inserted into the image. Section 5 of the attached appendix shows an exemplary format of the embedded data.

Section 6 of the attached appendix shows an exemplary format that contains the postmark of the Web Receipt for the completed work, as well as the Web Receipt for the completed work and the style sheet to display it.

The configuration properties for the Web Receipt Verification Service 2.2 are saved into class variables. Then the cryptographic object may be created to save on the overhead when use of the Web Receipt Verification Service is required. The cryptographic object requires a private key, which can be passed in the configuration information as well. Section 7 of the attached appendix shows an exemplary cryptographic object that decrypts the data found in the image.

Now referring to FIG. 3, a Web Receipt Service 3.1 may employ a Steganography Engine 3.2, a Cryptographic Engine 3.3, and a Postmarking Engine 3.4. The Web Receipt Service 3.1 comprises a server-based receipting application. The Web Receipt Service 3.1 provides a postmarked receipt, and a third party receipt and style sheet. The components provided by the Web Receipt Service 3.1 enable third party applications or systems to issue Web Receipts for transactions, tasks or work performed.

Creation of the Web Receipt is the responsibility of the Web Receipt Service 3.1. The Web Receipt Service 3.1 resides on the Internet or other accessible public network and can be accessed using standard web service protocols such as SOAP or XML-RPC. Connections to the Web Receipt Service 3.1 can be made over a secure connection such as SSL in order to protect sensitive information.

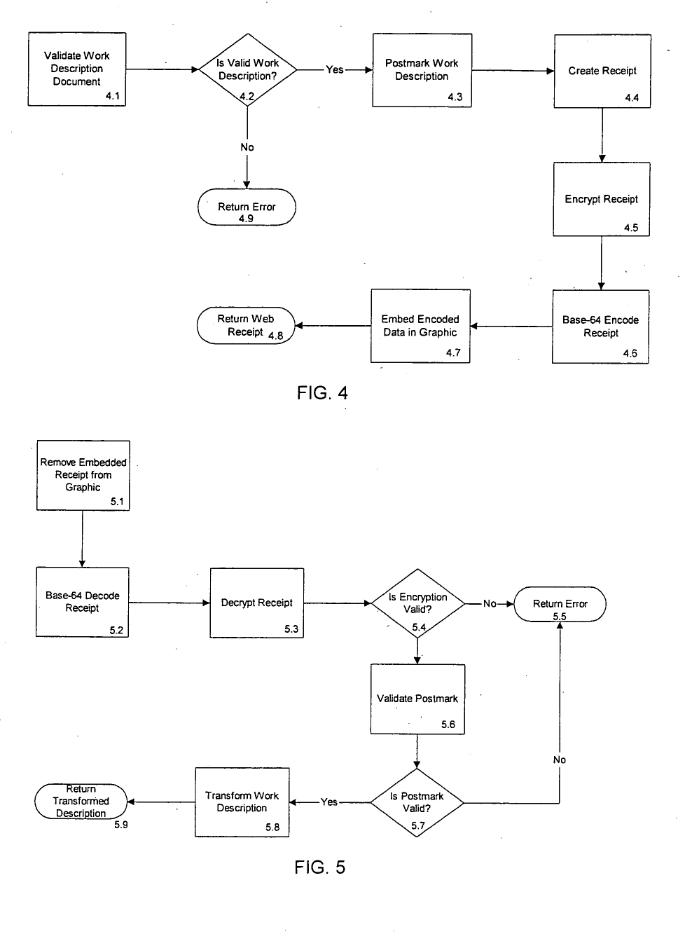

Now referring to the exemplary method shown in FIG. 4, a third party Internet service validates a work description document at step 4.1 and creates a documenting XML receipt and accompanying style sheet in XSLT. If the work description is valid (S4.2=Yes), the Internet service sends the work description document to a Web Receipt Service at step 4.3. If the work description is not valid (S4.2=No), an error signal may be returned at step 4.9. The Web Receipt Service may use a postmarking service to create the time-stamped, digitally signed hash of the receipt. The files and time-stamped hash may then be encoded and combined into an XML document to create a postmarked receipt at step 4.4. The postmarked receipt is protected using standard PKI based encryption using the public cryptographic key of a verification application of the Web Receipt Verification Service at step 4.5. Finally, the encrypted receipt is base-64 encoded again at step 4.6, injected in a GIF image using steganography at step 4.7, and returned to the third party Internet service at step 4.8. The Internet service may then retain a copy and return a copy in the form of a web page to the client.

In a preferred embodiment of the present invention, an interface is used as the basis for a class that is called to perform all of the service functionality of taking an XML work document, an XML style sheet, and an image, postmarking the XML work document and combining the elements into a XML formatted receipt document that is encrypted for a verification service. Steganography is used to embed the encrypted document into an image, which is returned to the caller.

Input Format:

The caller of the Web Receipt service has performed some work that is to be certified by the Web Receipt Service. The caller creates a document, called a receipt that describes the work that was accomplished. In a preferred embodiment, the receipt document is an XML document. The caller also creates a document that allows the receipt to be displayed inside a web browser, such as a style sheet. The receipt and the style document are passed to the Web Receipt Service. The receipt is then postmarked and the postmark, the receipt and the style sheet are returned by the Web Receipt Service in what is called a postmarked receipt.

Output Format:

The postmarked receipt data is contained within a steganographic image that has the receipt, the style sheet, and the postmark embedded within. The steganographic process takes a .gif file and, using a sorted color map, sets the “one” bit in a pixel to a higher or lower color map value depending on the bit found in the data to be inserted into the image. When the receipt image is returned, any alteration of the image data will alter the receipt itself. Therefore, use of image altering software on the image will render the receipt invalid, and is therefore detectable.

Section 8 of the attached appendix shows an exemplary listing of computer readable software codes that are used to obtain and return the steganographic image that has the receipt, the style sheet and the postmark embedded.

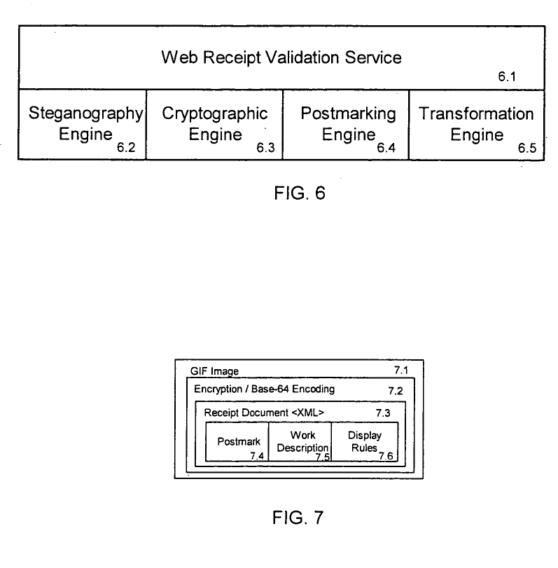

Now referring to FIG. 5 and FIG. 6, the Web Receipt Verification Service 6.1, upon receiving a Web Receipt for verification, decomposes the Web Receipt by reversing the process used to construct the Web Receipt in order to obtain the original time-stamped hash, XML receipt and style sheet. The Web Receipt Verification Service 6.1 removes the embedded receipt from the graphic at step 5.1; base-64 decodes the receipt at step 5.2, and decrypts the receipt at step 5.3. If the decryption is not valid (S5.4=No), an error is returned at step 5.5. If the decryption is valid (S5.4=Yes), the time-stamped hash is validated at step 5.6 using the postmarking service. If the time-stamped hash is not valid (S5.7=No), an error is returned at step 5.5. If the time-stamped hash is valid (S5.7=Yes), the application performs the XSL transformation at step 5.8 on the XML formatted receipt in order to create a displayable receipt with the sensitive information filtered out. The displayable receipt is then sent back to the user's web browser at step 5.9.

In a preferred embodiment of the present invention, a class validates a Web Receipt that has been created by the Web Receipt Service. The class expects the web page to have a form within it that contains a file upload field. The user supplies the filename for the Web Receipt graphic then presses a “submit button” which may be located on the graphic image of the Web Receipt or on a Web page interface presented to the user by the Web Receipt Service. Access to verification services may be controlled or restricted using passwords, digital certificates, or other identifiers. The file is uploaded and the Web Receipt is decomposed and evaluated. If the Web Receipt is validated successfully, the work description is transformed using the style sheet and sent back as a web page.

Section 9 of the attached appendix shows an exemplary listing of computer readable software codes that may be used to obtain a validated work description from a Web Receipt Verification Service 6.1.

Section 10 of the attached appendix shows an exemplary listing of computer readable software codes that are used to save the multipart form-data file data to a temporary file in the directory that the storage manager stores temporary files in. The file object is returned so the temporary data can be accessed later. The XML document, which is the receipt, is transformed into an html document, in turn parsing out sensitive information from the document.

Now referring to FIG. 6, the Web Receipt Verification Service 6.1 may employ a Steganography Engine 6.2, a Cryptographic Engine 5.3, a Postmarking Engine 6.4, and a Transformation Engine 6.5. The Web Receipt Verification Service 6.1 is a server-based verification application that provides a postmarked receipt, and a third party receipt and style sheet. The verification application resides in a web server and is accessible by the Internet through a web browser so end users can interact with the verification application. The verification application allows a user to view non-sensitive information contained within the Web Receipt, at the same time verifying that the Web Receipt is valid.

In a preferred embodiment of the present invention, a method is called to validate a previously created postmarked receipt that is contained within an image. Section 11 of the attached appendix shows an exemplary listing of computer readable software codes that perform the verification method. The stream that contains the data that makes up the image containing the postmarked receipt is passed in. The validated postmarked image will return the XML document and style sheet contained within.

Section 12 of the attached appendix shows an exemplary listing of computer readable software codes that are used to remove the steganography from data passed in. The data expected is an image that has steganography applied to an encrypted and encoded XML document that a caller has created as a receipt. The method returns the data that is within the image through the output stream that the caller has passed in.

Section 13 of the attached appendix shows an exemplary listing of computer readable software codes that may be used to take the data found within the steganographed image and extract the XML document. Data has an ascii preamble followed by base64 encoded data that is encrypted for a p12 key. The method reads the preamble and finds out the length of the encoded data. The encrypted data is extracted from the encoding and decrypted with the private key of the Web Receipt Service, returning the byte array.

Now referring to FIG. 7, the Web Receipts used in the Web Receipt service are designed to be self-containing, protective and usable. The Web Receipt service treats receipts as opaque values. Embedding the Web Receipts in an image 7.1 enables easy manipulation and presentation in a web page. Encryption 7.2 provides privacy and assures receipt integrity. The Web Receipts carry with them the time-stamped hash (postmark) of the receipt 7.4, the original receipt (work description) created by the third party service 7.5, and the style sheet (display rules) 7.6. The configuration of the Web Receipts mitigates the need to store any information required in order to display the receipt when requested.

Section 14 of the attached appendix shows an exemplary listing of computer readable software codes that may be used to extract Web Receipt description documents from an XML formatted Web Receipt that conforms to the Web Receipt dtd schema. The XML formatted Web Receipt is passed in and the method extracts the Web Receipt Document components into the document object and returns the base64 postmarked receipt data.

In preferred embodiments of the present invention, all encryption is performed using DES3, RSA or another PKI algorithm; however, the only certificates and keys used are those issued to the Web Receipt Verification Service. This protects the Web Receipts from tampering and unauthorized access. A principal benefit of this design comes from its simplicity in that it uses PKI but does not rely upon the issuance of certificates or private keys to individuals or organizations involved in the web transactions for which Web Receipts are created. Protection of the receipt is through encryption to a single public key belonging only to the Web Receipt Service. Only the Web Receipt Service can decrypt the Web Receipt.

In another preferred embodiment of the present invention, the method takes the receipt that is passed in and encrypts it to a public key specified by the configuration file. It then puts the encrypted receipt into a base64 encoding and prepends the encoding type and length. Section 15 of the attached appendix shows an exemplary listing of computer readable software codes that may be used to encrypt the receipt to a public key specified by the configuration file.

In another preferred embodiment, the sensitive information is not revealed to anyone, including the user requesting a view of the receipt. This is accomplished by using XSL transformations (XSLT) with the XML formatted receipt. Using XSLT strips out any sensitive information and transforms the rest of the XML receipt into a displayable format. This way, non-sensitive details about the work performed are displayed while sensitive details, required only for dispute resolution, are not revealed. Access to sensitive data is controlled in accordance with specific rules defined for a business process, such as dispute resolution.

Section 16 of the attached appendix shows an exemplary listing of computer readable software codes that may be used to combine all elements of the receipt into a single XML document. The XML documents that are passed are base-64 encoded prior to being placed within the document. The returned string is an XML document that is described by the “receiptdescription.dtd”.

Still further, steganography allows the postmarked receipts to be usable within a web browser environment as a graphic in web pages. While steganography offers some data hiding protection for the content, steganography technology is also employed to facilitate using graphics usable in a web page as a carrier for the postmarked receipt. The steganography used takes a GIF image and manipulates the image in a way that allows the data of the postmarked receipt to be spread across the bits that make up the color map.

Section 17 of the attached appendix shows an exemplary listing of computer readable software codes that may be used to apply steganography to an image in order to insert into the image the data that is passed in the input stream. From the color model passed in, the rgb palette is used to create an array that is returned. The color model is indexed such that it can be processed.

According to an aspect of the present invention, all receipts are treated as opaque pieces of data aside from the use of XML and XSL transformations (XSLT). This prevents building a service that needs to understand the specifics of third party service receipts, and allows any well-formed and valid XML receipt to be processed by simply using standard off-the shelf XML parsing engines and passing the result through.

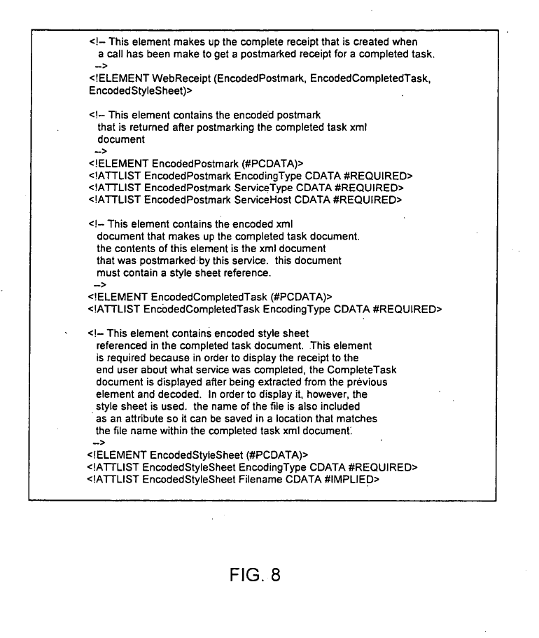

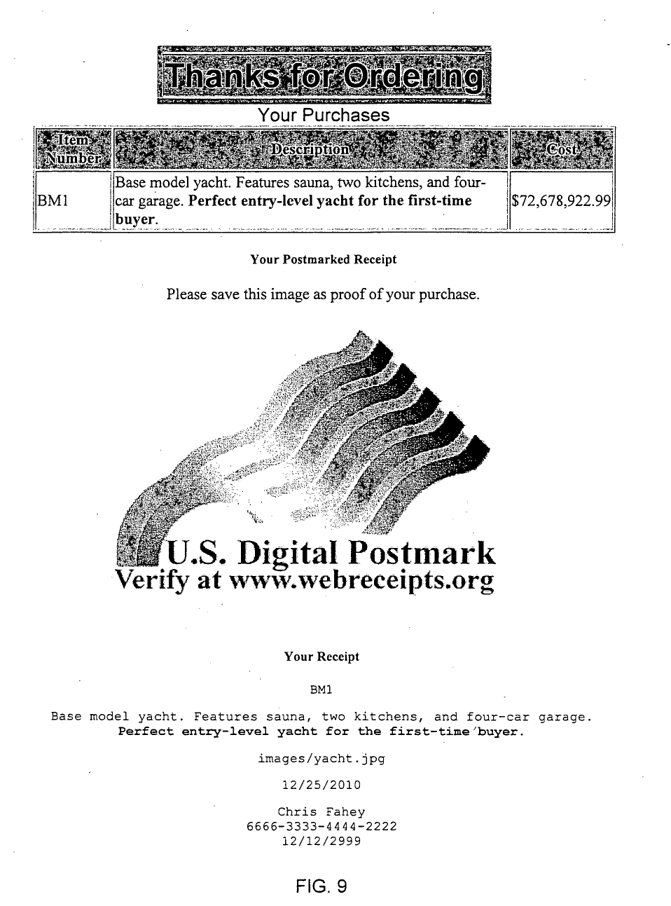

Referring now to FIG. 8, an example of the XML structure used in the postmarked receipt is outlined. In order to embed an XML document or binary data within an XML document, all elements are first encoded using the MIME base-64 encoding standard, and then inserted as data of the elements to which they belong. FIG. 9 illustrates a typical Web Receipt in its graphic form.

Although the present specification describes components and functions implemented in the embodiments with reference to particular standards and protocols, the invention is not limited to such standards and protocols. For example SOAP, XML, XSL, DES3, and the Internet are referred to throughout this specification as representing examples of the state of the art. However, such standards are periodically superseded by faster and more efficient equivalents having essentially the same functions. Accordingly, replacement standards and protocols having the same functions are considered equivalents.

While the invention has been described with reference to several exemplary embodiments, it is understood that the words that have been used are words of description and illustration, rather than words of limitation. Changes may be made, within the purview of the appended claims, as presently stated and as amended, without departing from the scope and spirit of the invention in its aspects. For example, the invention is readily adaptable to other types of electronic transactions conducted in a networked computer environment other than the World Wide Web. Although the invention has been described with reference to particular means, materials and embodiments, the invention is not intended to be limited to the particulars disclosed; rather, the invention extends to all functionally equivalent structures, methods and uses, such as are within the scope of the appended claims.

Computer Program

In greater detail, the attached appendix discloses the source code for the computer program of a preferred embodiment of the present invention that should be operating on a Web Receipt Service computer. Other required operating conditions include active connection to a communications pathway such as the Internet; power on state at both the client and the server; and an operating system such as Microsoft Windows NT, Windows XP or Windows 2000 installed and operating on both the client and the server.

1. A device that provides a digital receipt for a third-party electronic commerce transaction carried out over a public network, the receipt validating details of the electronic transaction and comprising a transaction record identifying transaction details, the device comprising a receipt system that receives the transaction record detailing a completed transaction, digitally signs and encrypts the transaction record, forms a digital receipt comprising the encrypted transaction record, embeds the digital receipt in a graphic to enable display in a Web page, and returns the digital receipt to at least one party to the completed transaction,
wherein details in the transaction record are protected from modification by the parties to the transaction.

2. The device of claim 1, further comprising a verification system to which each party may later present the digital receipt for verification, the verification comprising extracting the digital receipt from the graphic, decrypting the transaction record and returning details of the transaction to the presenting party,
wherein the presenting party may compare the transaction details to a previously stored version of the transaction record.

3. The device of claim 1, wherein the device provides a Web Receipt Service that creates “postmarked” digital receipts suitable for use within a web browser, the postmark comprising a date time stamp and identity of a trusted third party.

4. The device of claim 3, in which the trusted third party is a national postal authority.

5. The device of claim 3, in which the Web Receipt Service is accessible using standard web based protocols.

6. The device of claim 3, in which the Web Receipt Service generates a postmark or passes a time-stamped hash of the transaction details to a postmarking service.

7. A Web Receipt system that provides a Web Service, comprising
a receipt originating device,
a server-based receipting application, the Web Receipt system generating
a postmarked receipt and
a third party receipt and style sheet,
wherein, third parties are enabled to issue Web Receipts for at least one of tasks accomplished and work performed in electronic transactions.

8. The system of claim 7, in which access uses standard Web Service protocols and connections are made over a secure SSL connection to protect sensitive information.

9. The system of claim 7, in which an XML receipt and accompanying style sheet in XSLT are created and sent to a postmarking application, wherein the postmarking application uses a postmarking service to create a time-stamped hash of the receipt.

10. The system of claim 7, in which transaction records and time-stamped hash are encoded and combined into an XML document which is protected through the use of standard PKI based encryption and the public key of a verification application.

11. The system of claim 10, in which encrypted transaction records are encoded and then injected into a GIF image using steganography and returned to a third party service.

12. The system of claim 10, in which encryption is performed using DES3, RSA or another PKI algorithm, and the only certificates and cryptographic keys used are those issued to a Web Receipt Verification Service.

13. The system of claim 7, in which a Web Receipt Service uses PKI but does not rely upon the issuance of certificates or private keys to the individuals for whom Web Receipts are created.

14. The system of claim 7, in which protection of the transaction details is accomplished through encryption to a single public key belonging only to the Web Receipt Service and only the Web Receipt Service can decrypt it.

15. The system of claim 7, in which sensitive information is not revealed to anyone including the user requesting a view of the receipt.

16. The system of claim 15, in which XSLT is used to strip out any sensitive information and transform the rest of an XML receipt into a displayable format.

17. The system of claim 7, in which steganography is employed to hold the postmarked receipt and allow postmarked receipts to be usable within a web browser environment as a graphic in web pages.

18. The system of claim 17, in which the steganography used takes a GIF image and manipulates the image in a way that allows the data of the postmarked receipt to be spread across the bits that make up a color map.

19. The system of claim 7, in which all receipts are treated as opaque pieces of data aside from the use of XML and XSL transformations (XSLT), such that any well-formed and valid XML receipt can be processed by using standard off-the shelf XML parsing engines and passing the result through.

20. The system of claim 10, in which all elements are first encoded using the MIME base-64 encoding standard then inserted as data of the elements they belong to, in order to embed an XML document or binary data within an XML document.

21. A Web Receipt verification system, comprising
a receipt verification device, and
a server-based verification application, the Web Receipt verification system generating
a postmarked receipt, and
a third party receipt and style sheet,
wherein, Web Receipts are verified using the server-based verification application that is accessible from a public network through a Web browser.

22. The system of claim 21, in which a verification application allows a user to view non-sensitive information contained within a Web Receipt, at the same time verifying that the Web Receipt is valid.

23. The system of claim 21, in which a verification application decomposes a Web Receipt by reversing the process used to construct the Web Receipt in order to obtain the original time-stamped hash, XML receipt and style sheet.

24. The system of claim 21, in which a time-stamped hash is validated using the postmarking service, and if the time-stamped hash is valid, an XSL transformation is performed on the XML formatted receipt creating a displayable receipt with the sensitive information filtered out.

25. The system of claim 24, in which the displayable receipt is returned to a users Web browser.

26. The system of claim 21, in which the Web Receipts are self-containing, protective, and treated as opaque values.

27. The system of claim 21, in which the Web Receipts carry with them the time-stamped hash of the receipt, the original receipt created by the third party service, and the style sheet, mitigating the need to store any information required to display the receipt when requested.

28. A computer readable medium that stores a Web service program for providing a digital receipt as a Web Service for a third-party electronic commerce transaction carried out over a public network, the receipt validating details of the electronic transaction and comprising a transaction record identifying transaction details, the medium comprising at least one Web Service source code segment that:
receives the transaction record comprising details of a completed transaction;
digitally signs and encrypts the record;
forms a digital receipt comprising the encrypted transaction record;
embeds the digital receipt in a graphic to enable display in a Web page; and
returns the digital receipt to at least one party to the completed transaction,
wherein details in the transaction record are protected from modification by the parties to the transaction.

29. The medium of claim 28, in which each party may later present the digital receipt for verification, the verification comprising extracting the digital receipt from the graphic, decrypting the transaction record and returning details of the transaction to the presenting party, and
wherein the presenting party may then compare the transaction details to any previously stored version of the transaction details that the presenting party possesses.

30. The medium of claim 28, in which a Web Receipt Service creates “postmarked” digital receipts suitable for use within a Web browser, where the postmark comprises a date time stamp and identity of a trusted third party.

31. The medium of claim 30, in which the trusted third party is a national postal authority.

32. The method of claim 30, in which the Web Receipt Service is accessible using standard web based protocols.

33. The method of claim 30, in which the Web Receipt Service passes a time-stamped hash of the transaction details to the postmarking service or self-generates a postmark.

34. A method for providing a digital receipt as a Web Service for a third-party electronic commerce transaction carried out over a public network, the receipt validating details of the electronic transaction and comprising a transaction record identifying transaction details, the method comprising:
creating the transaction record based upon details of a completed transaction;
sending the transaction record to a computer that digitally signs and encrypts the record;
forming a digital receipt comprising the encrypted transaction record;
embedding the digital receipt in a graphic to enable display in a Web page; and
returning the digital receipt to at least one party to the completed transaction,
wherein details in the transaction record are protected from modification by the parties to the transaction.

35. The method of claim 34, in which each party may later present the digital receipt for verification, the verification comprising extracting the digital receipt from the graphic, decrypting the transaction record and returning details of the transaction to the presenting party, and
wherein the presenting party may then compare the transaction details to any previously stored version of the transaction details that the presenting party possesses.

36. The method of claim 34, in which a Web Receipt Service creates “postmarked” digital receipts suitable for use within a web browser, where the postmark comprises a date time stamp and identity of a trusted third party.

37. The method of claim 36, in which the trusted third party is a national postal authority.

38. The method of claim 36, in which the Web Receipt Service is accessible using standard Web based protocols.

39. The method of claim 36, in which the Web Receipt Service passes a time-stamped hash of the transaction details to the postmarking service or self-generates a postmark.

40. The method of claim 34, in which an XML receipt and accompanying style sheet in XSLT are created and sent to a postmarking application, wherein the postmarking application uses a postmarking service to create a time-stamped hash of the receipt.

41. The method of claim 34, in which transaction records and time-stamped hash are encoded and combined into an XML document which is protected through the use of standard PKI based encryption and the public key of a verification application.

42. The method of claim 40, in which encrypted transaction records are encoded and then injected into a GIF image using steganography and returned to a third party service.

43. The method of claim 40, in which encryption is performed using DES3, RSA or another PKI algorithm, and the only certificates and cryptographic keys used are those issued to a Web Receipt Verification Service.

44. The method of claim 34, in which a Web Receipt Service uses PKI but does not rely upon the issuance of certificates or private keys to the individuals for whom Web Receipts are created.

45. The method of claim 34, in which protection of the transaction details is through encryption to a single public key belonging only to the Web Receipt Service and only the Web Receipt Service can decrypt it.

46. The method of claim 34, in which sensitive information is not revealed to anyone including the user requesting a view of the receipt.

47. The method of claim 34, in which XSLT is used to strip out any sensitive information and transform the rest of an XML receipt into a displayable format.

48. The method of claim 34, in which steganography is employed to hold the postmarked receipt and allow postmarked receipts to be usable within a Web browser environment as a graphic in web pages.

49. The method of claim 47, in which the steganography used takes a GIF image and manipulates the image in a way that allows the data of the postmarked receipt to be spread across the bits that make up a color map.

50. The method of claim 34, in which all receipts are treated as opaque pieces of data aside from the use of XML and XSL transformations (XSLT), such that any well-formed and valid XML receipt can be processed by using standard off-the shelf XML parsing engines and passing the result through.
